(19) United States
(12) Patent Application Publication
(10) Pub. No.: US 2010/0031037 A1
(43) Pub. Date: Feb. 4, 2010

(54) SYSTEM AND METHOD FOR EXPORTING INDIVIDUAL DOCUMENT PROCESSING DEVICE TRUST RELATIONSHIPS

(76) Inventors: Sameer Yami, Irvine, CA (US); Amir Shahindoust, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/030,406

(22) Filed: Feb. 13, 2008

(51) Int. Cl. H04L 9/00

(52) U.S. Cl. 713/168

(57) ABSTRACT

The subject application is directed to a system and method for exporting individual document processing device trust relationships. User data tokens are first stored in memory associated with a primary document processing device, with each token corresponding to access settings of a document processing device configured for the user associated with the token. Each of the tokens also includes user identification data, user role data, and user permission data. Selection data of one or more user data tokens is then received. An encrypted user data token is then generated, and device selection data corresponding to the identity of a second document processing device is received. Each of the encrypted user data tokens is then output to the second document processing device based upon the received device selection data.

### BACKGROUND OF THE INVENTION

The subject application is directed generally to setting trust relationships in document processing devices. The application is particularly applicable to exporting individual trust relationship settings from one document processing device to another without the necessity of exporting an entire group of such settings.

Computing devices such as document processing devices are frequently shared among several or many users. Individual users typically have the ability to use one or more features of a device that is set to their individual preference or needs. Such document processing devices may include printers, copiers, scanners, facsimile machines, or devices referred to as multifunction peripherals, or MFPs, which have two or more of these functions. Such settings are sometimes referred to as trusted relationships.

A system administrator will typically set up a device such that features are made available in accordance with a user identification supplied at login. By way of example, given the relatively high cost of color printing relative to black and white printing, color output capability of a printing device may be limited to those individuals who have regular need for color output. In yet another example, only select individuals may have need for long distance facsimile transmissions. Thus, an administrator will set up a user such that various permissions will be available to that user on a particular device.

When an enterprise has more than one device, it is incumbent upon an administrator to set trusted relationships for users on more than one device. However, such a migration may be desired for individual cases; accordingly, a mass migration of user permissions is not desirable. For example, a new device may have been added to a particular department as an alternative to a similar device already in place. In another situation, a user may have an alteration or addition of job responsibilities, requiring that they have access to one or more additional devices with a similar trusted relationship as set earlier.

### SUMMARY OF THE INVENTION

In accordance with one embodiment of the subject application, there is provided a system and method for setting trust relationships in document processing devices.

Further, in accordance with one embodiment of the subject application, there is provided a system and method for exporting individual trust relationship settings from one document processing device to another without the necessity of exporting an entire group of such settings.

Still further, in accordance with one embodiment of the subject application, there is provided a system for exporting individual document processing device trust relationships. The system includes means adapted for storing in a memory associated with a primary document processing device a plurality of user data tokens, wherein each user data token corresponds to a plurality of access settings of a document processing device configured for a user associated therewith, wherein each user data token includes data corresponding to a plurality of data elements from the set comprising user role data, user permission data, and user identification data. The system also includes means adapted for receiving selection data corresponding to at least one selected user data token from the plurality thereof and encryption means adapted for generating an encrypted user data token corresponding to each user data token specified by received selection data. The system also includes means adapted for receiving device selection data corresponding to an identity of a second document processing device and output means adapted for outputting each encrypted user data token to the second associated document processing device in accordance with received device selection data.

In one embodiment of the subject application, the system also comprises means adapted for receiving each encrypted user data token from the primary document processing device at the second document processing device and decryption means adapted for decrypting each received encrypted user data token at the second document processing device. The system further comprises means adapted for importing user token data from each decrypted user data token to a database associated with operation of the second document processing device, means adapted for receiving login data from an associated user at the second document processing device, and means adapted for controlling operation of the second document processing device in accordance with decrypted user data corresponding to received login data.

In another embodiment of the subject application, the system also includes means adapted for storing key data corresponding to the primary document processing device, the key data including a public key portion and a private key portion and means adapted for receiving public key data corresponding to the second document processing device. In this embodiment, the encryption means includes means adapted for generating each encrypted user data token in accordance with the private key portion and received public key data.

In a further embodiment of the subject application, the system also comprises means adapted for storing key data corresponding to the second document processing device, the key data including a public key portion and a private key portion. In such embodiment, the decryption means includes means adapted for decrypting each received encrypted user data token in accordance with the private key portion corresponding to the second document processing device.

In yet another embodiment of the subject application, the system also includes means adapted for automatically generating and communicating encrypted user token data to the second document processing device upon each creation of a user data token on the primary document processing device.

Still further, in accordance with one embodiment of the subject application, there is provided a method for exporting individual document processing trust relationships in accordance with the system as set forth above.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for exporting individual document processing trust relationships according to one embodiment of the subject application;

FIG. 2 is a block diagram illustrating controller hardware for use in the system for exporting individual document processing trust relationships according to one embodiment of the subject application;

FIG. 3 is a functional diagram illustrating the controller for use in the system for exporting individual document processing trust relationships according to one embodiment of the subject application;

FIG. 4 is a flowchart illustrating a method for exporting individual document processing trust relationships according to one embodiment of the subject application;

FIG. 5 is a flowchart illustrating a method for exporting individual document processing trust relationships according to one embodiment of the subject application; and

FIG. 6 is a flowchart illustrating a method for exporting individual document processing trust relationships according to one embodiment of the subject application.

### DETAILED DESCRIPTION OF THE PREFERRED EMBODIMENT

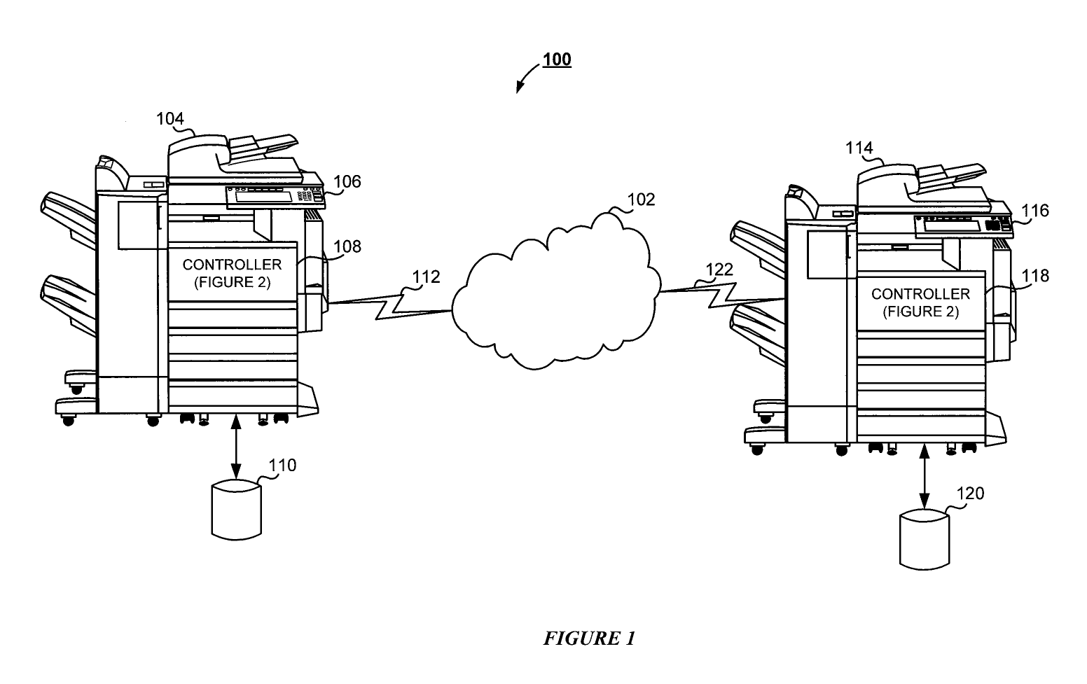

The subject application is directed to a system and method for setting trust relationships in document processing devices. In particular, the subject application is directed to a system and method for exporting individual document processing device trust. More particularly, the subject application is directed to a system and method for relationships exporting individual trust relationship settings from one document processing device to another without a necessity of exporting an entire group of such settings. It will become apparent to those skilled in the art that the system and method described herein are suitably adapted to a plurality of varying electronic fields employing token-based security including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for exporting individual document processing device trust in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, and any suitable combination thereof. In accordance with the preferred embodiment of the subject application, the computer network 102 is comprised of physical layers and transport layers, as illustrated by myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a first, or primary, document processing device 104 and a second document processing device 114, each of which are depicted in FIG. 1 as a multifunction peripheral device suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104 and 114 are suitably adapted to provide remote document processing services to external or network devices. Preferably, the document processing devices 104 and 114 include hardware, software, and any suitable combination thereof configured to interact with an associated user, a networked device, or the like.

According to one embodiment of the subject application, the document processing devices 104 and 114 are suitably equipped to receive a plurality of portable storage media including, without limitation, Firewire drive, USB drive, SD, MMC, XD, Compact Flash, Memory Stick, and the like. In the preferred embodiment of the subject application, the document processing devices 104 and 114 further include associated user interfaces 106 and 116 such as touch-screens, LCD displays, touch-panels, alpha-numeric keypads, or the like, via which an associated user is able to interact directly with the respective document processing device 104 or 114. In accordance with the preferred embodiment of the subject application, the user interfaces 106 and 116 are advantageously used to communicate information to the associated user and receive selections from the associated user. The skilled artisan will appreciate that the user interfaces 106 and 116 comprise various components suitably adapted to present data to the associated user, as are known in the art. In accordance with one embodiment of the subject application, the user interfaces 106 and 116 each comprise a display suitably adapted to display one or more graphical elements, text data, images, or the like to an associated user, receive input from the associated user, and communicate the same to a backend component such as the controllers 108 and 118, as explained in greater detail below. Preferably, the document processing devices 104 and 114 are communicatively coupled to the computer network 102 via suitable corresponding communications links 112 and 122. As will be understood by those skilled in the art, suitable communications links include, for example and without limitation, WiMax, 802.11a, 802.11b, 802.11g, 802.11 (x), Bluetooth, the public switched telephone network, a proprietary communications network, infrared, optical, or any other suitable wired or wireless data transmission communications known in the art.

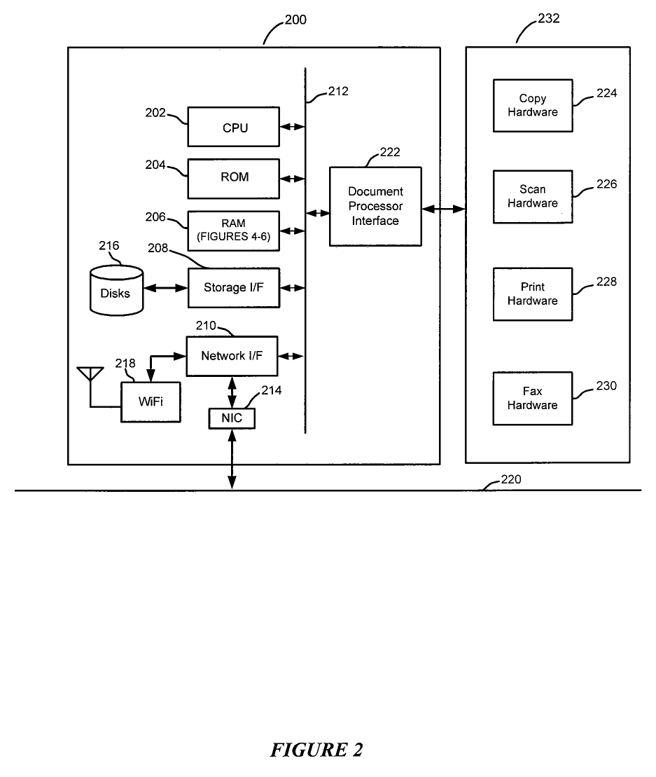

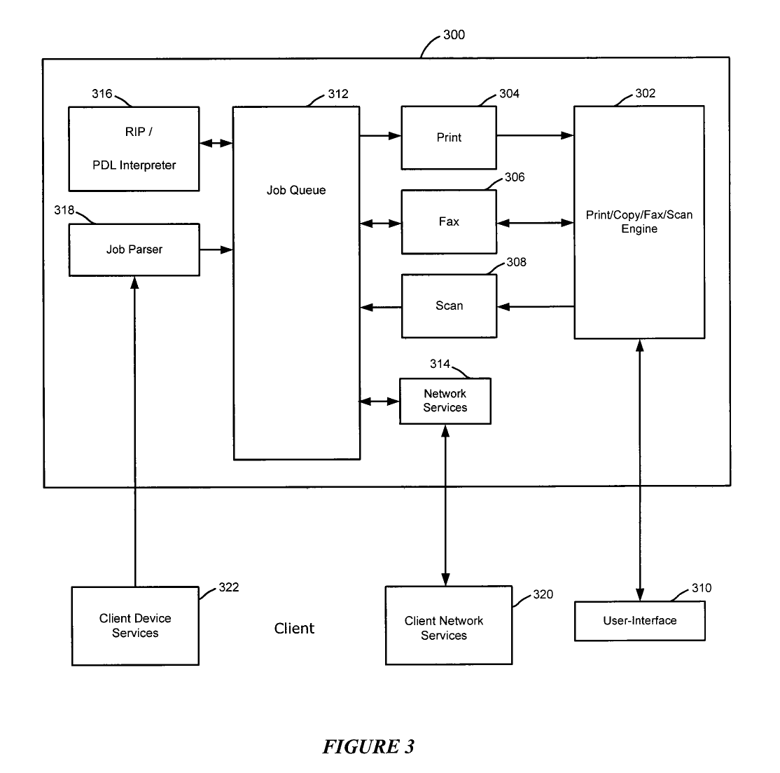

In accordance with one embodiment of the subject application, the document processing devices 104 and 114 further incorporate backend components, designated respectively as the controllers 108 and 118, suitably adapted to facilitate the operations of the corresponding document processing devices 104 and 114, as will be understood by those skilled in the art. Preferably, the controllers 108 and 118 are embodied as hardware, software, or any suitable combination thereof configured to control the operations of the associated document processing devices 104 and 114, facilitate the display of images via the user interfaces 106 and 116, direct the manipulation of electronic image data, and the like. For purposes of explanation, the controllers 108 and 118 are used to refer to any of the myriad components associated with the document processing devices 104 and 114, including hardware, software, or combinations thereof functioning to perform, cause to be performed, control, or otherwise direct the methodologies described hereinafter. It will be understood by those skilled in the art that the methodologies described with respect to the controllers 108 and 118 are capable of being performed by any general purpose computing system, known in the art and, thus, the controllers 108 and 118 are representative of such a general computing device and are intended as such when used hereinafter. Furthermore, the use of the controllers 108 and 118 hereinafter is for the example embodiment only, and other embodiments that will be apparent to one skilled in the art are capable of employing the system and method for exporting individual document processing device trust of the subject application. The functioning of the controllers 108 and 118 will better be understood in conjunction with the block diagrams illustrated in FIGS. 2 and 3, explained in greater detail below.

Communicatively coupled to the document processing devices 104 and 114 are respective data storage devices 110 and 120. In accordance with the preferred embodiment of the subject application, the data storage devices 110 and 120 are any mass storage devices known in the art including, for example and without limitation, magnetic storage drives, hard disk drives, optical storage devices, flash memory devices, or any suitable combination thereof In the preferred embodiment of the subject application, the data storage devices 110 and 120 are suitably adapted to store document data, image data, electronic database data, user identification data, security token data, private/public key data, applications, or the like. It will be appreciated by those skilled in the art that, while illustrated in FIG. 1 as being a separate component of the system 100, the data storage devices 110 and 120 are capable of being implemented as internal storage components of the document processing devices 104 and 114, components of the controllers 108 and 118, or the like such as, for example and without limitation, internal hard disk drives or the like.

Turning now to FIG. 2, illustrated is a representative architecture of a suitable backend component, i.e., the controller 200, shown in FIG. 1 as the controllers 108 and 118, on which operations of the subject system 100 are completed. The skilled artisan will understand that the controller 200 is representative of any general computing device known in the art that is capable of facilitating the methodologies described herein. Included is a processor 202 suitably comprised of a central processor unit. However, it will be appreciated by one of ordinary skill in the art that the processor 202 may advantageously be composed of multiple processors working in concert with one another. Also included is a non-volatile or read only memory 204, which is advantageously used for static or fixed data or instructions such as BIOS functions, system functions, system configuration data, and other routines or data used for operation of the controller 200.

Also included in the controller 200 is random access memory 206 suitably formed of dynamic random access memory, static random access memory, or any other suitable, addressable, and writable memory system. Random access memory 206 provides a storage area for data instructions associated with applications and data handling accomplished by processor 202.

A storage interface 208 suitably provides a mechanism for non-volatile, bulk, or long term storage of data associated with the controller 200. The storage interface 208 suitably uses bulk storage, such as any suitable addressable or serial storage such as a disk, optical, tape drive and the like as shown as 216, as well as any suitable storage medium, as will be appreciated by one of ordinary skill in the art.

A network interface subsystem 210 suitably routes input and output from an associated network, allowing the controller 200 to communicate to other devices. The network interface subsystem 210 suitably interfaces with one or more connections with external devices to the controller 200. By way of example, illustrated is at least one network interface card 214 for data communication with fixed or wired networks such as Ethernet, token ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer. In the illustration, the network interface 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by the bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device such as the document processing device 104, which includes the controller 200 of FIG. 2 (shown in FIG. 1 as the controllers 108 and 118) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality, as will be appreciated by one of ordinary skill in the art.

In the preferred embodiment, the engine 302 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices capable of performing one or more of the document processing operations listed above.

The engine 302 is suitably interfaced to a user interface panel 310, which panel 310 allows for a user or administrator to access functionality controlled by the engine 302. Access is suitably enabled via an interface local to the controller or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter, or any suitable mechanism for interchange of an electronic document to a format better suited for interchange with device functions such as print 304, facsimile 306, or scan 308.

Finally, the job queue 312 is in data communication with a parser 318, which parser 318 suitably functions to receive print job language files from an external device such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, a plurality of user data tokens is first stored in a memory associated with a primary document processing device. Each of the user data tokens corresponds to a plurality of access settings of a document processing device configured for the user associated with the corresponding token. Each of the user data tokens further includes data corresponding to a plurality of data elements from the set comprising user role data, user permission data, and user identification data. Selection data is then received that corresponds to at least one selected user data token from among the plurality of stored tokens. An encrypted user data token is then generated corresponding to each user data token specified by the received selection data. Device selection data is then received corresponding to the identity of a second document processing device. Each of the encrypted user data tokens is then output to the second associated document processing device in accordance with the received device selection data.

In accordance with one example embodiment of the subject application, key data is first stored in memory, e.g. the data storage device 110, associated with a primary document processing device 104 having public key and private key portions that correspond to the primary document processing device 104. The skilled artisan will appreciate that the public key portion of the key data is suitably available to other devices coupled to the computer network 102 for use in encrypting data to be transmitted to and decrypted by the primary document processing device 104.

User data tokens are then stored in the memory 110 associated with the document processing device 104, with each token corresponding to access settings of a document processing device 104 or 114 configured for the user associated with the token. In accordance with one embodiment of the subject application, each user data token includes data corresponding to data elements representing user role data, user permission data, user identification data, and the like. It will be understood by those skilled in the art that the user data tokens are suitably created upon the login of a user at the primary document processing device 104, received from a system administrator (not shown), or the like. It will be appreciated by those skilled in the art that the creation, encryption, and communication of the user data token is capable of being initiated automatically, whereupon the primary document processing device 104 communicates the user data token to one or more secondary document processing devices, e.g. the second document processing device 114, without user interaction. Selection data corresponding to at least one selected user data token is then received by the controller 108 or other suitable component associated with the primary document processing device 104.

Device selection data is then received by the controller 108 or other suitable component associated with the primary document processing device 104 corresponding to the identity of a second document processing device 114. The public key associated with the second document processing device 114 is then received by the controller 108 or other suitable component associated with the primary document processing device 104. In accordance with one embodiment of the subject application, the public key is retrieved via the computer network 102 from the second document processing device 114, has been previously stored in the associated data storage device 110, or the like. The controller 108 or other suitable component associated with the document processing device 104 then generates encrypted user data tokens in accordance with the received selection data using the received public key data associated with the selected second document processing device 114. In accordance with one embodiment of the subject application, the controller 108 or other suitable component associated with the primary document processing device 104 automatically generates and communicates the encrypted user tokens to the second document processing device 114 upon the creation of the token at the primary document processing device 104.

According to a further example embodiment of the subject application, the controller 118 associated with the second document processing device 114 facilitates the storage of key data corresponding to the second document processing device 114. As will be understood by those skilled in the art, the key data includes a public key portion and a private key portion. In accordance with one embodiment of the subject application, the private key portion is securely stored on the data storage device 120 associated with the second document processing device 114. The skilled artisan will appreciate that the public key is made available to other devices coupled to the computer network 102 for use in encrypting data intended for the second document processing device 114. Encrypted user data tokens are then received by the controller 118 or other suitable component associated with the second document processing device 114 from the primary document processing device 104 via the computer network 102.

Each of the received encrypted user data tokens are then decrypted by the controller 118 or other suitable component associated with the second document processing device 114 in accordance with the private key portion associated with the second document processing device 114. User token data from each decrypted user data token is then imported into a database associated with the second document processing device 114. In accordance with one example embodiment of the subject application, the database is suitably resident on the data storage device 120 communicatively coupled to the second document processing device 114. According to one embodiment of the subject application, the imported data is in LDAP Data Interchange Format (LDIF), as will be understood by those skilled in the art, and includes user role data, user permission data, and user identification data.

Upon login of an associated user at the second document processing device 114, decrypted user data corresponding to the received user data token is then retrieved from the database. That is, the associated user provides login data, such as a user ID/password, biometric data, or the like to the second document processing device 114 via the associated user interface 116. The controller 118 or other suitable component associated with the second document processing device 114 then uses the received user login information to retrieve user token data from the database on the data storage device 120 corresponding to the associated user. Thereafter, operations of the second document processing device 114 are controlled in accordance with the decrypted user data retrieved from the associated database.

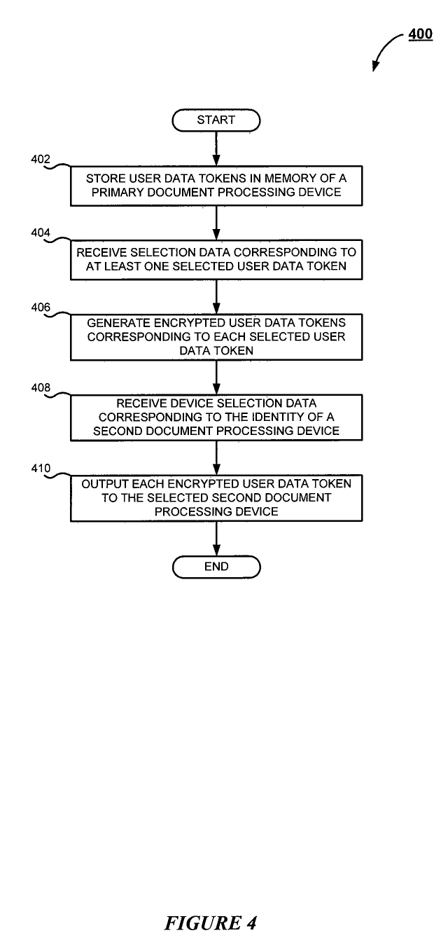

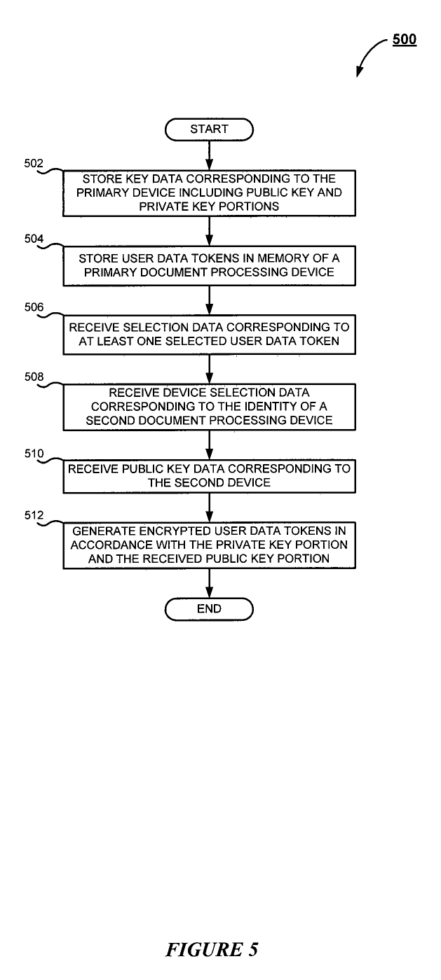

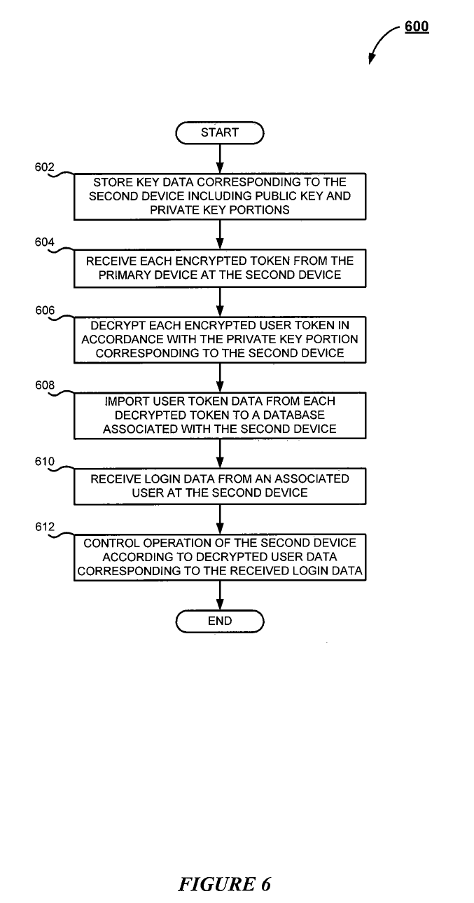

The skilled artisan will appreciate that the subject system 100 and components described above with respect to FIG. 1, FIG. 2, and FIG. 3 will be better understood in conjunction with the methodologies described hereinafter with respect to FIG. 4, FIG. 5, and FIG. 6. Turning now to FIG. 4, there is shown a flowchart 400 illustrating a method for exporting individual document processing device trust in accordance with one embodiment of the subject application. Beginning at step 402, user data tokens are first stored in memory associated with a primary document processing device 104. Preferably, the user data tokens are stored in a database resident on the data storage device 110 associated with the primary document processing device 104. It will be appreciated by those skilled in the art that each of the user data tokens corresponds to settings of an associated document processing device configured for the user associated with the corresponding user data token. In accordance with one example embodiment of the subject application, each of the user data tokens includes user identification data, user permission data, user role data, and the like.

At step 404, the controller 108 or other suitable component associated with the primary document processing device 104 receives selection data corresponding to at least one user data token stored in the database on the associated data storage device 110. The controller 108 or other suitable component associated with the primary document processing device 104 at step 406 generates encrypted user data tokens corresponding to each of the user data tokens selected at step 404. Device selection data is then received at step 408, corresponding to the identity of a second document processing device 114 to which the user data tokens are to be communicated. Each encrypted user data token is then output at step 410 to the second document processing device 114 as set forth by the received device selection data. That is, the primary document processing device 104 communicates the selected user data tokens as encrypted to the document processing device 114 identified by the received device selection data.

Referring now to FIG. 5, there is shown a flowchart 500 illustrating a method for exporting individual document processing device trust in accordance with one embodiment of the subject application. The methodology depicted in FIG. 5 begins at step 502, whereupon the controller 108 or other suitable component associated with the primary document processing device 104 facilitates the storage of key data in associated memory, e.g. the associated data storage device 110. It will be understood by those skilled in the art that the key data stored on the associated data storage device 110 includes a public key portion and a private key portion.

At step 504, the primary document processing device 104, via the associated controller 108 or other suitable component associated therewith, stores user data tokens in a suitable database on the associated data storage device 110. In accordance with one embodiment of the subject application, the user data tokens are generated automatically by the controller 108 or other suitable component associated with the document processing device 104 upon user login at the document processing device, upon receipt of user data from an associated administrator, or the like. According to a preferred embodiment of the subject application, each user data token stored on the associated data storage device 110 includes settings of a document processing device 104 or 114 configured for the user associated with the token. In such an embodiment, each token also includes data representing a user role, user permissions, user identification information, and the like corresponding to the user associated with the user data token. The controller 108 or other suitable component associated with the primary document processing device 104 then receives at step 506 selection data corresponding to one or more selected user data tokens.

Device selection data is then received at step 508, corresponding to the identity of a second document processing device 114 by the controller 108 or other suitable component associated with the primary document processing device 104. The controller 108 then receives at step 510 the public key associated with the second document processing device 114 based upon the received device selection data. In accordance with one embodiment of the subject application, the public key is retrieved via the computer network 102 from the second document processing device 114, has been previously stored in the associated data storage device 110, or the like. Flow then proceeds to step 512, whereupon encrypted user data tokens are generated by the controller 108 or other suitable component associated with the document processing device 104 in accordance with the received selection data using the received public key data associated with the selected second document processing device 114. In accordance with one embodiment of the subject application, the controller 108 or other suitable component associated with the primary document processing device 104 is capable of automatically generating and thereafter communicating encrypted user tokens to the second document processing device 114 following the creation of the token at the primary document processing device 104.

Turning now to FIG. 6, there is shown a flowchart 600 illustrating a method for exporting individual document processing device trust in accordance with one embodiment of the subject application. Beginning at step 602, key data associated with the second document processing device 114 inclusive of public and private key portions is stored on the data storage device 120 via operations of the controller 118 or other suitable component associated with the second document processing device 114. It will be appreciated by those skilled in the art that the public key portion is suitably made available to other electronic devices coupled to the computer network 102 so as to enable the secure communication of data to the second document processing device 114. The controller 118 or other suitable component associated with the second document processing device 114 then receives at step 604 encrypted user data tokens from the primary document processing device 104 via the computer network 102.

The received encrypted user data tokens are then decrypted at step 606 by the controller 118 or other suitable component associated with the second document processing device 114 using the private key portion stored on the associated data storage device 120 corresponding to the second document processing device 114. User token data from each decrypted user data token is then imported into a database associated with the second document processing device 114 at step 608. According to one embodiment of the subject application, the database is suitably resident on the data storage device 120 communicatively coupled to the second document processing device 114. It will be appreciated by those skilled in the art that the received user token data is capable of being, for example and without limitation, in LDAP Data Interchange Format (LDIF) or the like. Preferably, the imported user data corresponding to the decrypted user data tokens includes, for example and without limitation, user role data, user permission data, user identification data, and the like.

Login data is then received at step 610 from an associated user via the user interface 116, via remote access by an electronic device (not shown), or the like. The login data is then used by the controller 118 or other suitable component associated with the second document processing device 114 to retrieve one or more user data tokens from the database corresponding to the associated user. For example, user data tokens having user identification data matching the user identification received in the login data are retrieved from the database on the data storage device 120. Flow then proceeds to step 612, whereupon the operations of the second document processing device 114 are controlled in accordance with the decrypted user data retrieved from the associated database. That is, the user role data, user permission data, and user identification data are used to determine what operations are authorized on the second document processing device 114, the type of access the user associated with the retrieved tokens is allowed, and the like.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier being any entity or device capable of carrying the computer program: for example, a storage medium such as ROM or RAM; optical recording media such as CD-ROM; magnetic recording media such as floppy discs; any transmissible carrier such as an electrical or optical signal conveyed by electrical or optical cable; by radio; or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for exporting individual document processing device trust relationships comprising:
means adapted for storing in a memory associated with a primary document processing device, a plurality of user data tokens, each user data token corresponding to a plurality of access settings of a document processing device configured for a user associated therewith, each user data token including data corresponding to a plurality of data elements from the set comprising user role data, user permission data, and user identification data;
means adapted for receiving selection data corresponding to at least one selected user data token from the plurality thereof;
encryption means adapted for generating an encrypted user data token corresponding to each user data token specified by received selection data;
means adapted for receiving device selection data corresponding to an identity of a second document processing device; and
output means adapted for outputting each encrypted user data token to the second associated document processing device in accordance with received device selection data.

2. The system of claim 1 further comprising:
means adapted for receiving each encrypted user data token from the primary document processing device at the second document processing device;
decryption means adapted for decrypting each received encrypted user data token at the second document processing device;
means adapted for importing user token data from each decrypted user data token to a database associated with operation of the second document processing device; and
means adapted for receiving login data from an associated user at the second document processing device; and
means adapted for controlling operation of the second document processing device in accordance with decrypted user data corresponding to received login data.

3. The system of claim 1 further comprising:
means adapted for storing key data corresponding to the primary document processing device, the key data including a public key portion and a private key portion; and
means adapted for receiving public key data corresponding to the second document processing device;
wherein the encryption means includes means adapted for generating each encrypted user data token in accordance with the private key portion and received public key data.

4. The system of claim 2 further comprising:
means adapted for storing key data corresponding to the second document processing device, the key data including a public key portion and a private key portion; and
wherein the decryption means includes means adapted for decrypting each received encrypted user data token in accordance with the private key portion corresponding to the second document processing device.

5. The system of claim 1 further comprising means adapted for automatically generating and communicating encrypted user token data to the second document processing device upon each creation of a user data token on the primary document processing device.

6. A method for exporting individual document processing device trust relationships comprising the steps of:
storing in a memory associated with a primary document processing device a plurality of user data tokens, each user data token corresponding to a plurality of access settings of a document processing device configured for a user associated therewith, each user data token including data corresponding to a plurality of data elements from the set comprising user role data, user permission data, and user identification data;
receiving selection data corresponding to at least one selected user data token from the plurality thereof;
generating an encrypted user data token corresponding to each user data token specified by received selection data;
receiving device selection data corresponding to an identity of a second document processing device; and
outputting each encrypted user data token to the second associated document processing device in accordance with received device selection data.

7. The method of claim 6 further comprising the steps of:
receiving each encrypted user data token from the primary document processing device at the second document processing device;
decrypting each received encrypted user data token at the second document processing device;
importing user token data from each decrypted user data token to a database associated with operation of the second document processing device;
receiving login data from an associated user at the second document processing device; and
controlling operation of the second document processing device in accordance with decrypted user data corresponding to received login data.

8. The method of claim 6 further comprising the steps of:
storing key data corresponding to the primary document processing device, the key data including a public key portion and a private key portion; and
receiving public key data corresponding to the second document processing device;
wherein each encrypted user data token is generated in accordance with the private key portion and received public key data.

9. The method of claim 7 further comprising the steps of:
storing key data corresponding to the second document processing device, the key data including a public key portion and a private key portion; and
each received encrypted user data token is decrypted in accordance with the private key portion corresponding to the second document processing device.

10. The method of claim 6 further comprising the step of automatically generating and communicating encrypted user token data to the second document processing device upon each creation of a user data token on the primary document processing device.
